(19) United States
(12) Patent Application Publication
(10) Pub. No.: US 2004/0001735 A1
(43) Pub. Date: Jan. 1, 2004

(54) Curved profile keyboard having scissors-like key switch

(76) Inventors: Chien-Shih Hsu, Taipei (TW); Shin-Chan Lin, Taipei (TW)

Correspondence Address: SNELL & WILMER, ONE ARIZONA CENTER, 400 EAST VAN BUREN, PHOENIX, AZ, 850040001

(21) Appl. No.: 10/463,900

(22) Filed: Jun. 18, 2003

(30) Foreign Application Priority Data
Jun. 26, 2002 (TW) 091209637

(51) Int. Cl. B41J 5/12

(52) U.S. Cl. 400/472

(57) ABSTRACT

A keyboard includes an upper casing and a base. The upper casing having a first curved surface includes an area for accommodating a plurality of key switches. The base has a second curved surface, which corresponds to the first curved surface of the upper casing. The base includes a plurality of connection elements for connecting the key switches. Each of the key switches includes a scissors-like structure.

### CROSS REFERENCE TO RELATED APPLICATIONS

This application claims priority of Taiwan Patent Application Serial No. 091209637 entitled “Curved Keyboard Having Scissors-like Key Structure”, filed Jun. 26, 2002.

### FIELD OF INVENTION

The present invention relates to a curved profile keyboard, and more particularly, to a curved profile keyboard having scissors-like key switches.

### BACKGROUND OF THE INVENTION

Keyboards are one of the most popular peripherals for inputting characters, numerals or instructions into computer system. Surfaces of the key caps of a keyboard generally have different sloping angles for ergonomics purposes. With the modern technology improvement, the keyboard is designed as having ergonomically curved surface for providing users with more comfortable and healthy operation experiences.

A conventional curved profile keyboard, especially a keyboard for a desktop personal computer, usually includes key switches of mechanical or insertion-type structures. The insertion-type key switch typically includes a base, an elastic element, and a key cap with an insertion element. Due to the structure of the insertion element, connection elements of the base usually have a complicated structure for connecting to the insertion elements of the key caps, allowing the key caps to be vertically movable relative to the base. The complicated structure of the connection elements of the base, however, increases the costs and difficulties of manufacturing the curved base in the conventional curved profile keyboard.

The base of key switch is generally made by injection molding method. As a result, several injection moldings of the connection elements with different sloping angles should be made in accordance with the curvature of the keyboard. This process costs a lot of time and money. In addition, different moldings of the base should be provided for different curvatures of the curved keyboard. It not only complicates the manufacturing process but also increases the manufacturing costs.

To solve the problems described above, a desirable design of the curved profile keyboard is needed to simplify the manufacturing process and decrease the manufacturing costs.

### SUMMARY OF THE INVENTION

It is one aspect of the present invention to disclose a keyboard having a curved surface by utilizing connection structure peculiar to scissors-like key switches and to simplify the process of manufacturing the connection elements of different angles.

It is another aspect of the present invention to disclose a curved profile keyboard structure, which has a metal base to hold the scissors-like key switches. The metal base can be bent to form a curved surface by a simple process so that it can simplify the manufacturing process and lower the manufacturing costs.

It is a further aspect of the present invention to disclose a curved profile keyboard structure, which includes a plurality of key caps having top surfaces of the same identical sloping angle to lower the manufacturing costs.

The present invention provides a keyboard including an upper casing and a base. The upper casing, having a first curved surface, includes an area for accommodating a plurality of the key switches. The base has a second curved surface, which corresponds to the first curved surface of the upper casing. The base is made of metal and includes a plurality of the connection elements for connecting the key switches. Each of the key switches includes a scissors-like structure. The key switches further include a plurality of key caps and the top surfaces of the key caps slope at substantially identical angles.

The keyboard further includes a lower casing engaging with the upper casing to form a housing, wherein the base is disposed within the housing. The scissors-like structure includes a first arm and a second arm, and the first arm is rotatably coupled to the second arm. The scissors-like structure further includes a connector rotatably and movably connecting to one of the connection elements of the base.

### BRIEF DESCRIPTION OF THE DRAWINGS

FIG. 1 is a top view of the curved profile keyboard in accordance with one embodiment of the present invention; and

FIG. 2 is a cross-sectional view of the keyboard illustrated in FIG. 1.

### DETAILED DESCRIPTION

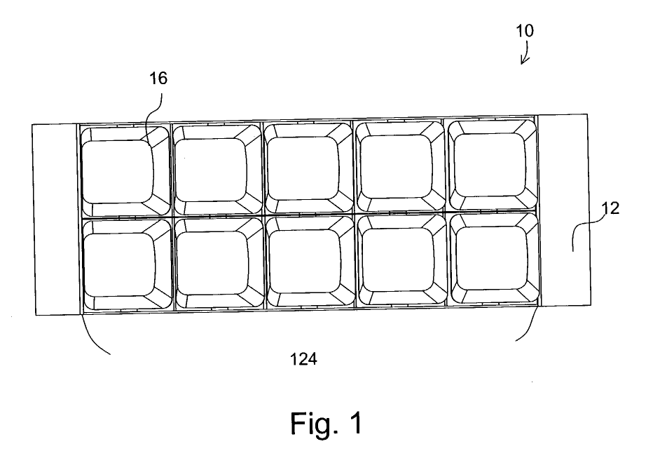

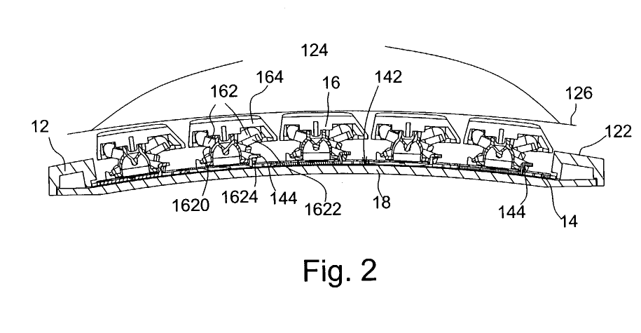

The present invention discloses a curved profile keyboard having a scissors-like structure to simplify the manufacturing process and decrease the manufacturing costs. These and other features and advantages of the present invention will become more apparent and completed from the following detailed description and the appended drawings FIG. 1 and FIG. 2.

FIG. 1 and FIG. 2 are respectively a schematic top view and a cross-sectional view of an exemplary keyboard 10 in accordance with one embodiment of the present invention. A keyboard 10 has an upper casing 12 and a base 14. The upper casing 12 has a first curved surface 122, e.g. a convex surface. The convex surface protrudes outwardly and has a curvature identical to the arc 126. The upper casing 12 further includes an area 124 for accommodating a plurality of key switches 16. Each of the key switches 16 has a scissors-like structure 162. The base 14 has a second curved surface 142 corresponding to the first curved surface 122 of the upper casing 12. The base 14 further includes a plurality of connection elements 144 for respectively connecting a plurality of key switches 16.

The base 14 of an exemplary embodiment is made of metal and the connection elements 144 are disposed on the base 14 with a predetermined distance between two adjacent connection elements. The metal base 14 is bent by a simple process to form a convex surface 142 corresponding to the convex surface 122 of the upper casing 12. It should be noted that although the upper casing 12 and the base 14 have been described as a convex surface, those skilled in the art should appreciate that the curved surface hereinafter includes a concave surface (i.e. a surface curves inwardly) or any other ergonomically curved surface.

In addition, the distance between two connection elements 144 of the base 14 varies with the curvatures of the base 14, especially when the surface of the base 14 is concave. While the curved surface is concave, the predetermined distance needs to become larger as the positions of the connection elements 144 become closer to the center of the curved surface so as to avoid the key switches 16 interfering with each other due to the improper distance.

The scissors-like structure 162 includes a first arm 1620 and a second arm 1622. The first arm 1620 is movably coupled to the second arm 1622. The scissors-like structure 162 further includes a connector 1624, which is rotatably and movably connected to one of the connection elements 144 of the base 14. It is noted that the scissors-like structure 162 may be similar to prior art scissors-like structures and is not elaborated here when prior art approach is adopted.

Furthermore, the key switches 16 include a plurality of key caps 164, and each surface of the key caps 164 substantially slopes at an identical angle. In other words, each of the key caps 164 substantially has the identical size, shape, and the sloping angle of the surface. Therefore, the keyboard 10 of the curved surface can fit in with the user's operation behavior without the needs of manufacturing key caps having different sloping angles of surfaces.

The keyboard 10 further includes a lower casing 18 engaging with the upper casing 12 to form a housing so that the base 14 is disposed within the housing. The lower casing 18 also has a curved surface corresponding to the curved profile of the keyboard. However, the actual shape of the lower casing 18 is not limited to the description above. The function of shape of the lower casing 18 is engaging with the upper casing 12 to form a housing, providing a space to accommodate the base 14, and seating the keyboard steadily on a plane, e.g. a desktop. It is noted that other components of the key switches 16, e.g. membrane switch layer, the elastic element, etc. that are non-essential to this invention, are not elaborated here, but they are required in practice.

The above description only sets forth a preferred embodiment of the invention, and is not intended to limit the scope, applicability, or configuration of the invention in any way. Rather, various changes may be made in the function and arrangement of the elements described in the embodiment without departing from the spirit and scope of the invention. Thus, the protected scope of the present invention is as set forth in the appended claims.

What is claimed is:

1. A keyboard, comprising:
an upper casing having a first curved surface, said upper casing comprising an area for accommodating a plurality of key switches; and
a base having a second curved surface corresponding to said first curved surface of the upper casing, said base comprising a plurality of connection elements for respectively connecting said key switches;
wherein each of the key switches comprises a scissors-like structure.

2. The keyboard of claim 1, wherein said first curved surface of the upper casing and said second curved surface of the base are respectively convex surface.

3. The keyboard of claim 1, wherein said base is made of metal.

4. The keyboard of claim 1, further comprising a lower casing engaging with said upper casing to form a housing, wherein said base is disposed within said housing.

5. The keyboard of claim 1, wherein said scissors-like structure comprises a first arm and a second arm, and said first arm is rotatably coupled to said second arm.

6. The keyboard of claim 1, wherein said scissors-like structure comprises a connector rotatably and movably connecting to one of said connection elements of the base.

7. The keyboard of claim 1, wherein said key switches comprise a plurality of key caps, and each surface of said key caps slopes at substantially identical angles.

8. A keyboard, comprising:
an upper casing having a first convex surface, said upper casing comprising an area for accommodating a plurality of key switches;
a metal base having a second convex surface corresponding to said first convex surface of the upper casing, said metal base comprising a plurality of connection elements for respectively connecting said key switches; and
a lower casing engaging with said upper casing to form a housing, wherein said metal base is disposed within said housing;
wherein each of the key switches comprises a scissors-like structure with a connector rotatably and movably connecting to said connection element of the metal base.

9. The keyboard of claim 8, wherein said key switches comprise a plurality of key caps, and each surface of said key caps slopes at substantially identical angles.
